(19) United States
(12) Patent Application Publication
(10) Pub. No.: US 2012/0268562 A1
(43) Pub. Date: Oct. 25, 2012

(54) IMAGE PROCESSING MODULE AND IMAGE PROCESSING METHOD THEREOF FOR 2D/3D IMAGES CONVERSION AND FRAME RATE CONVERSION

(75) Inventor: TZUNG-REN WANG, Tainan City (TW)

(73) Assignee: HIMAX TECHNOLOGIES LIMITED, Tainan City (TW)

(21) Appl. No.: 13/090,875

(22) Filed: Apr. 20, 2011

(51) Int. Cl. H04N 13/00

(52) U.S. Cl. 348/44; 348/E13.001

(57) ABSTRACT

An image processing module including a depth acquiring unit, a motion estimation unit and a motion compensation unit is provided. The depth acquiring unit receives a plurality of original images and is configured to detect depth information of each original image. The motion estimation unit receives the original images and is configured to detect motion information of each original image. When the image processing module is in a normal mode, the motion estimation unit adjusts the motion information of each original image according to the detected depth information of each original image. The motion compensation unit performs interpolation and outputs a plurality of display images according to the original images and the adjusted motion information of each original image.

### BACKGROUND OF THE INVENTION

1. Field of the Invention

The invention relates generally to an image processing module and an image processing method thereof, and more particularly to convert 2D images into 3D images and convert the frame rate of displayed image by employing depth information and motion information.

2. Description of Related Art

In recent years, with advances in the fabricating techniques of electrical-optical and semiconductor devices, flat panel displays (FPDs), such as liquid crystal displays (LCDs), have been developed. Due to the advantageous features of the LCDs, for example, high space utilization efficiency, low power consumption, radiation-free, and low electrical field interference, LCDs have become mainstream in the market.

In order to enhance the image quality of the LCD, some manufacturers increase the frame rate of the LCD by generating a plurality of intermediate images according to a plurality of original images, and inserting the intermediate images between the original images. Before generating the intermediate images, motion estimation is performed on the original images, so as to obtain a motion vector corresponding to each region of the original images. Thereafter, objects in the original images are detected according to the motion vector of each region, usually the regions in the same object have the same motion vector, and the objects are moved along a movement trajectory in the original images, so as to generate the intermediate images.

Moreover, as three-dimensional (3D) displays have become mainstream nowadays, a major research emphasis from the manufacturers is in converting 2D images into 3D images. Generally speaking, the method for converting a 2D image into a set of 3D images including a left eye image and a right eye image usually firstly needs to find out a corresponding depth map including depth values of all regions/pixels of the 2D image. The depth value may be determined according to the color and/or brightness of the region/pixel. The objects in the foreground and the background are typically detected by a depth value of each region in the 2D image, and then the object in the foreground/background are found out according to the depth value, usually the regions in the same object have the same depth value. Finally, the set of 3D images is generated according to the depth map and the 2D image.

However, when the movement of the objects in the original images is insignificant, the motion vector of each region in the original images has a small magnitude, and thus objects cannot be accurately detected. In more detail, the motion vector of the edge regions of the moving objects is fail to detected accurately, so as to effect the accuracy of interpolation. Moreover, when the color and brightness of the moving object and the background/neighbor objects are close to each other, the depth values of the object and the background/neighbor objects are approximately the same, which further contributes to the inaccuracy of the object detection and result in generating the inaccurate set of 3D images. It is necessary to provide a module/method to increase the accuracy of the 2D/3D conversion and the frame rate conversion.

### SUMMARY OF THE INVENTION

Accordingly, the invention is directed to an image processing module and an image processing method thereof capable of detecting objects according to both the depth information and the motion information, and thereby enhancing an accuracy of object detection.

An embodiment of the invention provides an image processing module, including a depth acquiring unit, a motion estimation unit, and a motion compensation unit. The depth acquiring unit receives a plurality of original images and is configured to detect depth information of each of the original images. The motion estimation unit receives the original images and is coupled to the depth acquiring unit, the motion estimation unit being configured to detect motion information of each of the original images. When the image processing module is in a normal mode, the motion estimation unit adjusts the motion information of each of the original images according to the detected depth information of each of the original images. the motion compensation unit performs interpolation and outputs a plurality of display images according to the original images and the adjusted motion information of each of the original images.

According to an embodiment of the invention, when the image processing module is in an image transformation mode, the depth acquiring unit adjusts the depth information of each of the original images according to the motion information of each of the original images, and outputs a set of stereo image images of each of the original images according to each of the original images and the adjusted depth information of each of the original images.

According to an embodiment of the invention, the depth acquiring unit includes a depth generating unit, a depth adjustor and a depth-image-based rendering unit. The depth generating unit receives the original images and is configured to detect depth information of each of the original images. The depth adjustor receives the depth information and the motion information of each of the original images. When the image processing module is in the image transformation mode, the depth adjustor adjusts the depth information of each of the original images according to the motion information of each of the original images. The depth-image-based rendering unit is coupled to the depth adjustor unit and receives the original images. When the image processing module is in the image transformation mode, the depth-image-based rendering unit outputs a set of stereo image images of each of the original images according to the adjusted depth information of each of the original images and each of the original images.

An embodiment of the invention provides an image processing method adapted for an image processing module. The image processing method includes the following steps. A plurality of original images are received. The depth information of each of the original images is detected. The motion information of each of the original images is detected. When the image processing module is in the normal mode, the motion information of each of the original images is adjusted according to the detected depth information of each of the original images, performs interpolation, and a plurality of display images are outputted according to each of the original images and the adjusted motion information of each of the original images.

According to an embodiment of the invention, the image processing method further includes: when the image processing module is in the image transformation mode, the depth information of each of the original images is adjusted according to the motion information of each of the original images, and a set of stereo image images of each of the original images are outputted according to each of the original images and the adjusted depth information of each of the original images.

According to an embodiment of the invention, each the set of the stereo image images includes at least one left eye image and at least one right eye image respectively.

According to an embodiment of the invention, the stereo image images are generated by a depth-image-based rendering method.

According to an embodiment of the invention, when the image processing module is in the image transformation mode, the original images are 2D images.

According to an embodiment of the invention, the display images include the original images and a plurality of interpolated images

In summary, in the image processing module and the image processing method thereof in accordance with embodiments of the invention, when the image processing module is in the normal mode, the motion information of each of the original images is adjusted according to the depth information of each of the original images, so as to detect objects according to the adjusted motion information of each of the original images, and to output a plurality of display images through motion compensation. Therefore, by referencing the depth and motion information of each of the original images with each other and making the corresponding adjustments, the accuracy of object detection can be enhanced.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of an image processing module according to an embodiment of the invention.

FIGS. 2A and 2B are respective schematic diagrams of the depth information and the motion information of the original images according to an embodiment of the invention.

FIG. 3 is a schematic diagram of the depth acquiring unit depicted in FIG. 1 according to an embodiment of the invention.

FIG. 4 is a schematic diagram of an image processing method according to an embodiment of the invention.

### DESCRIPTION OF EMBODIMENTS

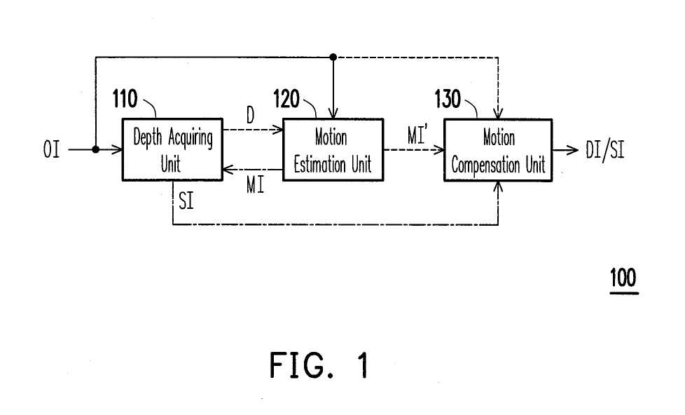

FIG. 1 is a schematic diagram of an image processing module according to an embodiment of the invention. Referring to FIG. 1, in the present embodiment, an image processing module 100 includes a depth acquiring unit 110, a motion estimation unit 120, and a motion compensation unit 130. The depth acquiring unit 110 receives a plurality of original images OI (2D images) and is configured to detect depth information D of each of the original images OI. The depth information D of each of the original images OI may be all or a portion of a depth image/map of each of the original images OI. The motion estimation unit 120 receives the original images OI and couples to the depth acquiring unit 110, and is configured to detect motion information MI of each of the original images OI. The motion information MI of each of the original images OI may be all or a portion of a motion vectors/map of each of the original images OI. In more detail, each region of the original images has a motion vector which is found according to a motion estimation algorithm (for example, Block Matching algorithm). Moreover, the region may be as small as a pixel.

When the image processing module 100 is in a normal mode (i.e. the dotted line), the motion estimation unit 120 receives depth information D of each of the original images OI from the depth acquiring unit 110. Moreover, the motion estimation unit 120 generates the motion information MI of each of the original images OI and adjusts the motion information MI of each of the original images OI according to the depth information D of each of the original images OI, so as to output the adjusted motion information MI′. On a same original image OI, assuming a distributed state of the depth information D of the original image OI (i.e. the distributed location of the regions formed by the same depth values) is different from a distributed state of the motion information MI thereof (i.e. the distributed location of the regions formed by the same motion vectors), then the motion vectors of the difference regions in the motion information MI is adjusted, such that the distributed state of the adjusted motion information MI′ approaches the distributed state of the depth information D.

The motion compensation unit 130 receives the original images OI and the adjusted motion information MI′ of each of the original images OI, and detects/segments at least one object in each of the original images OI according to the adjusted motion information MI′ of each of the original images OI (e.g., the regions having the same motion vector are considered as a object). Next, the motion compensation unit 130 performs interpolation according to the adjusted motion information MI′ of each of the original images OI so as to generate at least one interpolated image. Then, the motion compensation unit 130 outputs a plurality of display images DI. A quantity of the display images DI may be several times (e.g., 2 or 3 times) the original images OI, and the multiple value determines a ratio of the frame rate and the frame input frequency for the display.

Moreover, the display images DI includes the original images OI and a plurality of interpolated images (i.e. the derivative images generated after motion compensation and used for insertion between the original images OI), in which the interpolated images may be respectively disposed after the corresponding original images. For example, when the frame rate for display is 120 Hz and the input frame frequency is 60 Hz, then a quantity of the interpolated images is equal (i.e. 1 times) to the quantity of the original images OI, and the quantity of the display images is 2 times the original images OI per second. When the frame rate for display is 180 Hz and the frame input frequency is 60 Hz, then the quantity of the interpolated images is 2 times the quantity of the original images OI, and the quantity of the display images is 3 times the original images OI.

In the present embodiment, adjusting the motion information MI of each of the original images OI according to the depth information D of each of the original images OI is equivalent to adjusting/refining the motion information MI of the edge regions of an object detected by the motion information MI of each of the original images OI according to the object detected by the depth information D of each of the original images OI. In more detail, the motion vectors of the edge regions of a moving object of a original image are usually inaccuracy/disorder, and the inaccuracy/disorder motion vectors cause the inaccuracy of interpolated images.

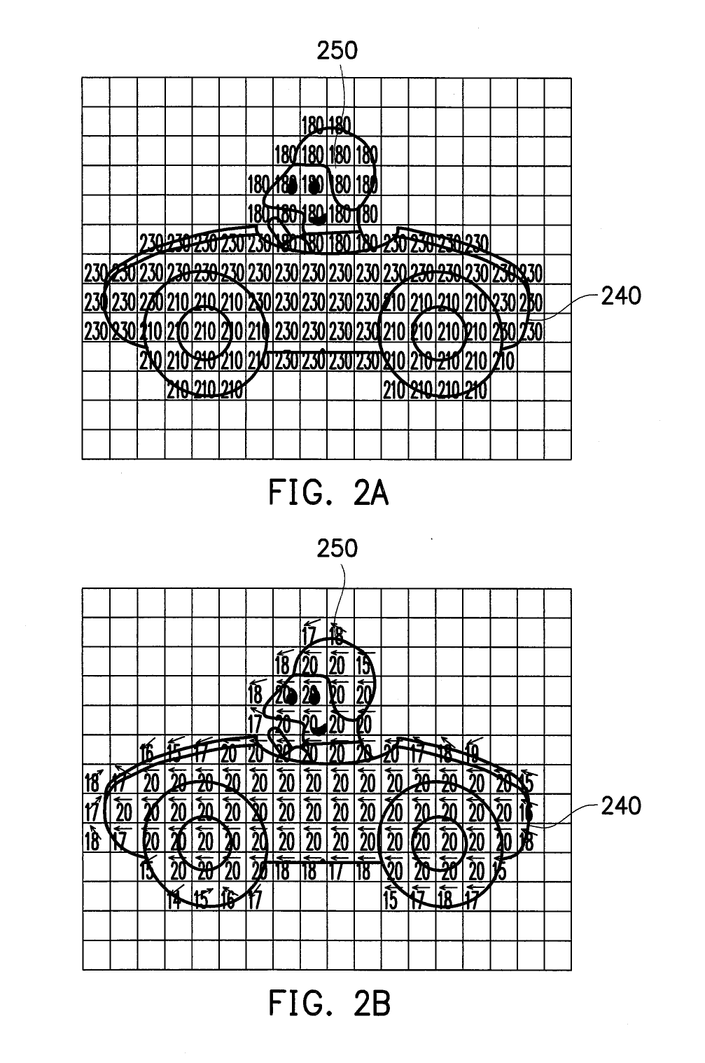

FIGS. 2A and 2B are respective schematic diagrams of the depth information and the motion information of the original images according to an embodiment of the invention. Referring to FIGS. 2A and 2B, in the present embodiment, FIG. 2A is a schematic diagram of the depth information of the original images OI, and FIG. 2B is a schematic diagram of the motion information of the original images OI, in which the original images OI are divided into a plurality of regions. Moreover, a depth value (i.e. depth information) and a motion vector (i.e. motion information) of each region are respectively detected by the depth acquiring unit 110 and the motion estimation unit 120 (showing in FIG. 1). However, in other embodiments of the invention, the depth value and the motion vector of each pixel may be detected, and the invention is not limited thereto. For clarity of the drawings, FIGS. 2A and 2B label only a part of the depth values and motion vectors to complement the description hereafter.

As shown in FIG. 2B, assume the motion vectors of most of the regions including the car 240 and driver 250 are the same (ex. motion vector [symbol] ), but the motion vectors of the edge regions of the car 240 and driver 250 are disorder. In the present embodiment, since the car 240 and driver 250 (i.e. objects) may be not accurately detected by merely consulting the motion information in FIG. 2B. In this embodiment, the car 240 and driver 250 are considered as an object if the motion vectors of the regions of the object are supposed to be the same. In order to detect objects accurately, the depth information displayed in FIG. 2A may be consulted. According to FIG. 2A, the regions having depth values of 180, 210 and 230 include the car 240 and driver 250. Therefore, the motion information of the car 240 and driver 250 in FIG. 2B is adjusted to be similar or the same, namely, the motion vectors of the edge regions of the car 240 and driver 250 is adjusted to about [symbol] , thereby increasing a detection accuracy of the car 240 and driver 250. In addition, the depth value may be 0˜255 (i.e., 8 bit), the object having the depth value 255 represents the nearest object. On the contrary, the depth value 0 represents the farthest object.

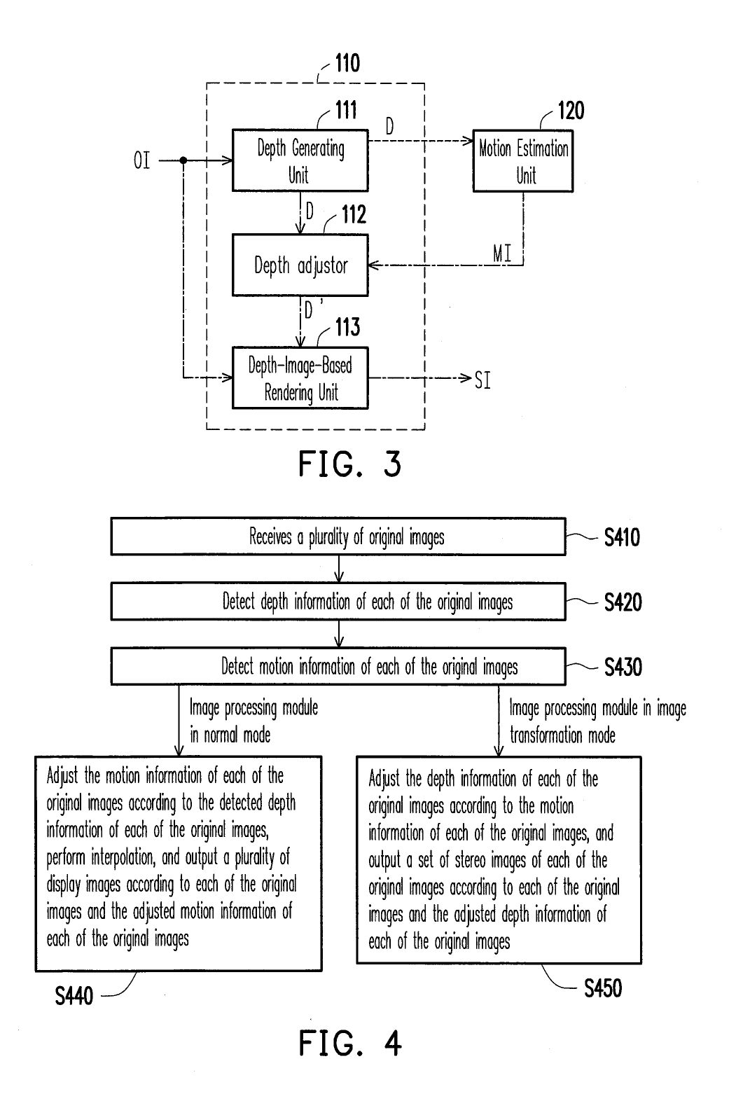

In addition, the image processing module 100 may be switched to an image transformation mode, so as to transform the 2D images to a set of stereo images (3D images). When the image processing module 100 is in the image transformation mode (i.e. the dot-slash line), the depth acquiring unit 110 generates the depth information D of each of the original images OI, and adjusts the depth information D according to the received motion information MI of each of the original images OI, so as to detect the objects in the original images OI and adjusts the corresponding depth values of regions of the objects. Thereafter, the depth acquiring unit 110 may output a set of stereo images SI according to each of the original images OI and the adjusted depth information D′ (shown in FIG. 3) of each of the original images OI. The motion compensation unit 130 may sequentially transmit each set of the stereo images SI, in which each set of the stereo images SI may be generated by a depth-image-based rendering (DIBR) method, and each set of the stereo images SI may respectively include a left eye image and a right eye image at least.

In the present embodiment, adjusting the depth information D of each of the original images OI according to the motion information MI of each of the original images OI is equivalent to adjusting an object detected by the depth information D of each of the original images OI according to an object detected by the motion information MI of each of the original images OI.

Referring again to FIGS. 2A and 2B, assume the depth values of the regions including the car 240 are different, and the depth values of the regions including the car 240 is different from the depth values of the regions including the driver 250. In the present embodiment, by solely consulting the depth values of FIG. 2A, the car body and tires of the car 240 and the driver 250 may be viewed as different objects with abnormal depth relation to each other, such that the corresponding displacement quantities of the car body and tires of the car 240 and the driver 250 in the left and right eye images are different. Therefore, the motion information shown in FIG. 2B may be consulted. Referring to FIG. 2B, the region having the motion vectors [symbol] is the regions including the car body and tires of the car 240 and the driver 250. Therefore, the depth values of the regions including the car body and tires of the car 240 and the driver 250 are adjusted to be similar or the same. Namely, the depth values 180 of the regions including the driver 250 may be adjusted to depth values 225, and the depth values 210 of the regions including the tires of the car 240 may be adjusted to depth values 227.

FIG. 3 is a schematic diagram of the depth acquiring unit depicted in FIG. 1 according to an embodiment of the invention. Referring to FIGS. 1 and 3, the depth acquiring unit 110 includes a depth generating unit 111, a depth adjustor 112 and a depth-image-based rendering unit 113 (DIBR). The depth generating unit 111 receives the original images OI and is configured to detect depth information of each of the original images OI. When the image processing module 100 is in the normal mode, the depth generating unit 111 outputs the depth information D of each of the original images OI to the motion estimation unit 120. When the image processing module 100 is in the image transformation mode, the depth generating unit 111 outputs the depth information D of each of the original images OI to the depth adjustor 112, the depth adjustor 112 receives the depth information D and receives the motion information MI of each of the original images OI from the motion estimation unit 120. Moreover, the depth adjustor 112 adjusts the depth information D of each of the original images OI according to the motion information MI of each of the original images OI, and the adjusted depth information D′ of each of the original images OI is outputted to the depth-image-based rendering unit 113.

The depth-image-based rendering unit 113 is coupled to the depth adjustor 112 and receives the original images OI. When the image processing module 100 is in the normal mode, the depth-image-based rendering unit 113 may be turned off. When the image processing module 100 is in the image transformation mode, the depth-image-based unit 113 receives the adjusted depth information D′ of each of the original images OI, and therefore the depth-image-based unit 113 outputs a set of stereo images SI according to each of the original images OI and the adjusted depth information D′ of each of the original images OI. In other embodiment, the depth adjustor 112 may be combined with the depth generating unit 111.

In view of the foregoing description, the operation of the image processing module 100 may be compiled as an image processing method. FIG. 4 is a schematic diagram of an image processing method according to an embodiment of the invention. Referring to FIG. 4, in the present embodiment, a plurality of original images are received (Step S410). Thereafter, the depth information of each of the original images is detected (Step S420), and the motion information of each of the original images is detected (Step S430). When the image processing module is in the normal mode, the motion information of each of the original images is adjusted according to the depth information of each of the original images, performing interpolation, and a plurality of display images are outputted according to each of the original images and the adjusted motion information of each of the original images (Step S440).

When the image processing module is in the image transformation mode, the depth information of each of the original images is adjusted according to the motion information of each of the original images, and a set of stereo images of each of the original images is outputted according to each of the original images and the adjusted depth information of each of the original images (Step S450). Since details of the foregoing steps may be gathered by reference to the description of the image processing module, further elaboration thereof is omitted hereafter.

In view of the foregoing, in the image processing module and the image processing method thereof in accordance with embodiments of the invention, when the image processing module is in the normal mode, the motion information of each of the original images is adjusted according to the depth information of each of the original images, so as to detect objects according to the adjusted motion information of each of the original images, and to output a plurality of display images through motion compensation. When the image processing module is in the image transformation mode, the depth information of each of the original images is adjusted according to the motion information of each of the original images, so as to detect the objects according to the adjusted depth information of each of the original images, and accordingly output a plurality of sets of stereo image images. Therefore, by referencing the depth and motion information of each of the original images with each other and making the corresponding adjustments, the accuracy of object detection can be enhanced.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. An image processing module, comprising:
a depth acquiring unit receiving a plurality of original images, configured to detect depth information of each of the original images;
a motion estimation unit receiving the original images and coupling to the depth acquiring unit, configured to detect motion information of each of the original images; and
a motion compensation unit;
wherein the motion estimation unit adjusts the motion information of each of the original images according to the detected depth information of each of the original images, the motion compensation unit performs interpolation and outputs a plurality of display images according to each of the original images and the adjusted motion information of each of the original images.

2. The image processing module as claimed in claim 1, wherein the display images comprise the original images and a plurality of interpolated images.

3. The image processing module as claimed in claim 1, wherein the depth acquiring unit generates depth information of the plurality of regions of the each of original images; the motion estimation unit generates motion information of a plurality of regions of each of original images so as to detect at least one object and adjusts the motion information of the edge regions of the detected object according to the depth information of each of the original images.

4. An image processing module, comprising:
a depth acquiring unit receiving a plurality of original images, configured to detect depth information of each of the original images; and
a motion estimation unit receiving the original images and coupling to the depth acquiring unit, configured to detect motion information of each of the original images;
wherein the depth acquiring unit adjusts the depth information of each of the original images according to the motion information of each of the original images, and outputs a set of stereo images of each of the original images according to each of the original images and the adjusted depth information of each of the original images.

5. The image processing module as claimed in claim 4, wherein the set of the stereo images comprises at least one left eye image and at least one right eye image respectively.

6. The image processing module as claimed in claim 4, wherein the depth acquiring unit comprises:
a depth generating unit receiving the original images, configured to detect depth information of each of the original images;
a depth adjustor receiving the depth information and the motion information of each of the original images, and when the image processing module is in the image transformation mode, the depth generating unit adjusts the depth information of each of the original images according to the motion information of each of the original images; and
a depth-image-based rendering unit coupled to the depth adjustor and receiving the original images, and when the image processing module is in the image transformation mode, the depth-image-based rendering unit outputs the set of stereo images of each of the original images according to the adjusted depth information of each of the original images and each of the original images.

7. The image processing module as claimed in claim 4, wherein when the image processing module is in the image transformation mode, the original images are two-dimensional (2D) images.

8. An image processing method adapted for an image processing module, the method comprising:
receiving a plurality of original images;
detecting depth information of each of the original images; and
detecting motion information of each of the original images;
wherein when the image processing module is in a normal mode, adjusting the motion information of each of the original images according to the detected depth information of each of the original images, performing interpolation, and outputting a plurality of display images according to each of the original images and the adjusted motion information of each of the original images.

9. The image processing method as claimed in claim 8, further comprising:
when the image processing module is in an image transformation mode, adjusting the depth information of each of the original images according to the motion information of each of the original images, and outputting a set of stereo images of each of the original images according to each of the original images and the adjusted depth information of each of the original images.

10. The image processing method as claimed in claim 9, wherein the set of the stereo images comprises at least one left eye image and at least one right eye image respectively.

11. The image processing method as claimed in claim 10, wherein the stereo image images are generated by a depth-image-based method.

12. The image processing method as claimed in claim 9, wherein when the image processing module is in the image transformation mode, the original images are 2D images.

13. The image processing method as claimed in claim 8, wherein the display images comprise the original images and a plurality of interpolated images.
